(19) United States
(12) Patent Application Publication
(10) Pub. No.: US 2022/0068087 A1
(43) Pub. Date: Mar. 3, 2022

(54) CONDITIONAL SUPPORT MANAGEMENT SYSTEM

(71) Applicant: Murat OZTERMIYECI, Istanbul (TR)

(72) Inventor: Murat OZTERMIYECI, Istanbul (TR)

(21) Appl. No.: 17/414,974

(22) PCT Filed: Mar. 13, 2019
(86) PCT No.: PCT/TR2019/050158

§ 371 Date: Jun. 17, 2021

(30) Foreign Application Priority Data
Dec. 17, 2018 (TR) 2018/19554

(51) Int. Cl. G07F 17/32; G06Q 20/40; G06Q 20/12

(52) U.S. Cl. CPC G07F 17/3244; G06Q 20/127; G06Q 20/407

(57) ABSTRACT

A conditional support management system includes at least one fan, at least one team supported by or in connection with the at least one fan, at least one player playing in the at least one team or independently, at least one goal or activity, wherein the at least one team or the at least one player are competing for achievement for the at least one goal or activity, a server system comprising databases of the at least one team, the at least one player, and the at least one goal or activity through a software and bringing the databases into service via Internet, a platform manager providing a management of the software and other elements, communication devices using the software by authorities supplied by the platform manager allowing for accessing database information through a satellite or base stations.

### CROSS REFERENCE TO THE RELATED APPLICATIONS

This application is the national stage entry of International Application No. PCT/TR2019/050158, filed on Mar. 13, 2019, which is based upon and claims priority to Turkish Patent Application No. 2018/19554 filed on Dec. 17, 2018, the entire contents of which are incorporated herein by reference.

### TECHNICAL FIELD

The present invention relates to software and communication system intended to manage the material and moral support system in the case of an incident which may be considered to be conditional. The invention particularly encompasses an innovation for electronically and digitally managing the system allowing for morally or financially supporting the teams, persons, and activities based on the conditions and designed especially for sports activities and entertainment purposes without limitation.

### BACKGROUND

There have been contests with the purposes of war, sports, or entertainment since people started to live as communities. One of the most famous ones of them is Greek sports activities and the war games of the Roman Empire. There may surely be various purposes of these activities such as keeping the society busy or enhancing the competitive sense in addition to the sports and entertainment purposes. The spectators of such activities have developed mostly temporary emotional bonds and supportive attitudes. However, supporting a team, a player, or an entertainment artist (even a movie star or an opinion leader) to the degree of devotion started almost at the late 19th century. Particularly the soccer teams in England and the matches between them spread throughout the world.

In the early 20th century and later, the sports activities and the matches became an essential part of all societies. All activities from the soccer teams to the Olympics, from the boxing matches to the dancing competitions, whether they are related to the sports or not, started to gain supporters. The increasing numbers of the fans of a team or a player leaded to an income due to the matches. For example, the prize which is given to the team winning the game increases, while the sales amount of the tickets of a famous soccer match. The value and popularity of the players surely increase together with the team. This example is the same for soccer, football and basketball, and similar consequences are observed for the other sports activities, even the entertainment activities.

Currently, various income methods are developed for the sports activities. The financial income ways based on the ticket earnings from the spectators of the matches, the broadcasting earnings of the matches, and the activities for the betting games concerning such matches has arisen in addition to the matches between the teams and rewarding the winning party. The main point for gaining money from the team sports, competitions and contests, and the entertainment activities is to increase the number of the fans and the devotion of these fans. Accordingly, the sports clubs and memberships, and the promotional products produced with the names of the teams or the persons are the factors increasing the income. The main purpose here is to increase the interest in the sports, the team, the player or the star. Increasing this interest allows for increasing the sports activities, the values of the teams of the persons, and the bets concerning thereof. However, one problem encountered in increasing these activities is that the emotional supports of the fans do not turn to money, or the fans are lost when a step which is not preferable for the fans is wrongfully taken.

In the prior art, a Turkish Patent application no. 2007/01766 is present. The teaching of the invention of said patent discloses a system usually operated by the GSM operators and allowing the fans to send premium for the sports activities of the teams they are supporting by means of phone subscription or to send premium through the GSM credits.

Another patent is a Canadian patent no. CA2859436 which is present in the prior art. In said patent, a platform is disclosed which is basically configured to support (to be sponsor for) a business idea. In this platform, the database in which business ideas are incorporated as in the property purchase and sales platforms and the database of the investors of said business ideas are matched.

Another patent is a British patent no. GB2370891 which is present in the prior art. The invention of said patent discloses a website on fund raising. Said fund raising website is related to presenting a project via a website instead of presenting it by door-to-door presentation of the project in order to find resource for an investment and to a virtual environment where the people who need money and the fund investors to supply the money meets.

Another patent is a U.S. patent no. US2010004055 which is present in the prior art. The invention of said patent relates to an online donation-based game platform intended for raising fund in the credit form from those who are included in the network in the games played through an online network and allowing for sharing that after the game score is obtained.

Another patent is a U.S. patent no. US2011295749 which is present in the prior art. The invention of said patent discloses a software-based application allowing a donation organization to demand donation via mobile phones and the people who desire to donate to said donation organization to also donate via mobile phones.

Another patent is a U.S. patent no. US2016275752 which is present in the prior art. The invention of said patent discloses a system in which the competitors in a competition or game are basically represented by “an avatar” via software, the participants or supporters grade or give money for said avatar, and they grade them down in turn in the case of failure.

Another patent is a U.S. patent no. US2017262939 which is present in the prior art. The invention of said patent discloses a sponsorship management system. In said sponsorship management system, the activities and the sponsors of these activities participate. One characteristic of said sponsorship system is that the sponsorship may be rejected and also other decisions may be made such as withdrawal.

Another patent is an international patent Application No. WO2018104581 which is present in the prior art. The invention of said patent discloses a sponsorship management system allowing for sponsorship via virtual currency and also for an interactive communication. The invention of said patent also allows for sponsorship for any kind of activities such as business, entertainment, sports, etc. through virtual money in a virtual environment. During the sponsorship, the sponsors and the beneficiaries of the fund are in communication through various communication ways such as asking or answering questions.

It is obvious that there are many money raising systems for particularly crowdfunding and business activities. However, an interactive system has not been found which may be financially and morally supported directly by the real fans of the sports activities comprising team games and personal game activities.

### SUMMARY

The conditional support management system of the invention is intended to provide an electronic and digital management system meeting the conditions that a sports activity, competition, investment, etc. are monitored by the fans through an interactive online communication and supported financially and morally, the organizers of the activity is supported if the activity achieves the aim and the supports are withdrawn if the activity does not achieve the aim.

One of the advantages of the conditional support management of the invention is that it is a system enabling those who perform the activity, particularly the sports teams and players to directly monitor positive or negative reactions of the fans and to focus on the achievement.

Another advantage of the conditional support management system of the invention is that it allows the fans to directly invest in the activity to be supported, but to recover the money in the case that the activity does not eventuate as intended.

Another advantage of the conditional support management system of the invention is not just transferring money to a sports team but to increase the success motivation of the activities by transferring money in the case of achievement.

Another advantage of the conditional support management system of the invention is to support the projects for the sports team (for example, player transfer and field building) as well as supporting the team, player, and the activities.

Another advantage of the conditional support management system of the invention is that it allows for obtaining approval within the laws and for the art activities, science competition, business enterprises or investments, as well as the sports activities.

### BRIEF DECRIPTION OF THE DRAWINGS

FIG. 1 is the drawing of the conceptual design illustrating the components of the conditional support management system of the invention.

FIG. 2 is the flow chart illustrating the selection of the subscription and payment ways of the conditional support management system of the invention.

FIG. 3 is the flow chart illustrating the support manners for a sports activity in a conditional support management system of the invention.

### Reference Numerals of the Sections and Parts to Serve for Describing the Invention

1—Platform manager
1a—Operator

2—Internet

3—Satellite

4—Base station

5—Modem

6—Firewall

7—Player database

8—Team database

9—Goal or activity database

10—Web server

11—Software

12—Player

13—Team

14—Goal or activity

15—Communication device

16—Fan

17—Server system

### Flow Numbers to Serve for Describing the Invention

10—subscription to the platform

20—inputting identity and other required information

30—inputting the data of the payment means

40—controlling platform manager

50—selecting the team and players to be supported

60—the approval of subscription and notification to the fan

100—selecting the operation to be supported

110—selecting the support condition

120—receiving and reserve the support payment

130—the approval of the support upon examining the result

140—refunding the payment to the fan

140—receiving the platform payment

150—releasing the payment

### DETAILED DESCRIPTION OF THE EMBODIMENTS

The conditional support management system of the invention mainly includes team or personal activities. However, said system will be used not only for the sports activities, but also for all competition activities, entrepreneurship, and investment activities. The examples will be used for the team sports for ease of understanding the system. It is obvious that this preference is not an obligation.

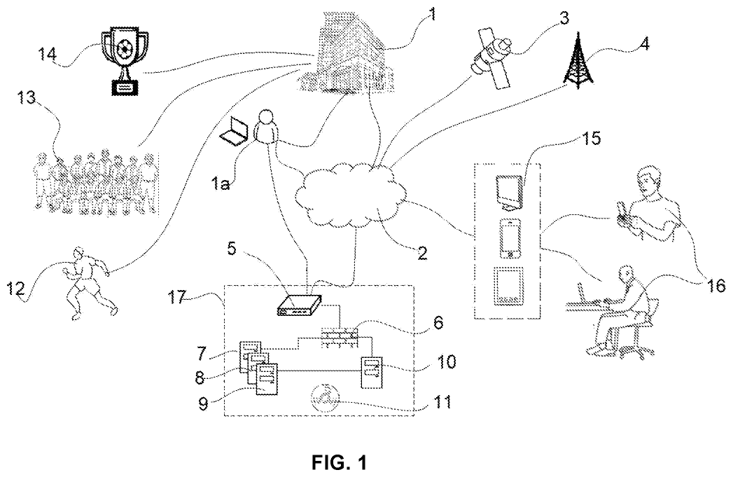

The main features of the conditional support management system of the invention is illustrated in the drawing of FIG. 1 presented as a conceptual design. The conditional support management system comprises mainly at least one fan (16), at least one team supported by or in connection with said fan (16), at least one player (12) playing in said team (13) or independently, at least one goal or activity (14) for which said team (13) or said player (12) are competing for achievement, a server system (17) comprising the databases of said team (13), said player (12), and said goal or activity (14) through a software (11) and bringing it into service via Internet (2), a platform manager (1) providing the management of said software (2) and other elements, the communication devices (15) using said software (11) by the authorities supplied by the platform manager (1) allowing for accessing database information through the satellite (3) or base stations (4), and at least one fan (16) accessing the databases of said team (13), said player (12) and said goal or activity (14) through said software (11) and said communication devices (15) and providing the conditional support.

In the conditional support management system of the invention, the players (12) are incorporated in the player database (7), the teams (13) in the team database (8), goal or activities (14) in the goal or activity database (9). These databases are managed through software (11) in the server system (17) and they are brought into use through the modem (5) and the firewall (6). The software and the databases may be surely located a cloud system, instead of the server system (17), if desired. The management of the server system (17), the software (11), and the databases, i.e. the management of the entire system is carried out by the platform manager (1) or preferably the operator (1a) in said platform manager (1). The platform manager (1) allows for obtaining the support of a fan (16) of the condition is met and for refunding by deducting the operation cost if the condition is not met. This may be carried out by an operator manually or by software (11). The operator (1a) may optionally be a hardware and software system managed by the artificial intelligence. The platform manager (1) may be a company, foundation, corporation, or a person. It is a company providing service for the sports teams and players in the intended system. However, this should not be a limitation.

In the conditional support management system of the invention, the players (12) may be the players of a team or independent players in the individual sports activities. There may be artists or entrepreneurs if the system is an art, or business enterprise instead of the sports, There may be a. team name, in the case that there are teams (13). There may be no need for it, in the individual games which are not played in teams, or there may be varieties such as Turkish team, British team, etc. in the games like the Olympic games. If the system is an activity of art, there may be a group name or “the team” term may not be used. In a business enterprise, if there are teams, conventional “team” term may be used or it may not be needed if there are no teams. If it is a goal or activity (14), there may be cup name of a sports match or directly a match name may be used. If it is a sports investment or player transfer rather than a match, the name of said activity may be used. In the individual sports, there may be a race name or a match. If the activity is an activity of art, there may be stage name, concert, a competition, etc. If it is a business enterprise or investment, the name of the activity or the name of the investment may be used. In the conditional support management system of the invention, the player (12) and the team (13) rarely changes in practice. For example, a fan (16) will support only one team (13) in practice. However, it may be surely changed. Also, a fan (16) may be a fan of a team (13), but may provide a conditional support for the different players (12) in said team. Similarly, a fan (16) may provide a conditional support for a couple of players (12) of a team (13) and various goals or activities (14) such as the match (game), competition, player transfer or investment in different environments.

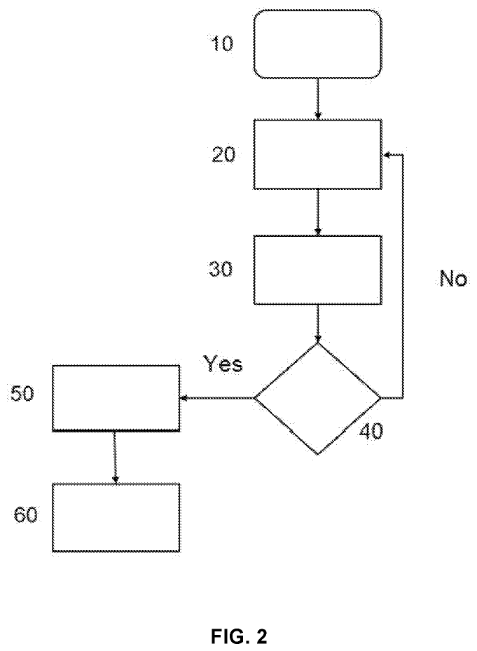

In the conditional support management system of the invention, a fan (16) may support at least one team (13), at least one player (12), or at least one goal or activity (14). They may support all or at least one of them. The fan (16) term may be used for a sports activity, but they may also be the followers or supporters of an artist or those performing similar acts. The access of a fan (16) is firstly provided by accessing the software (11) through a software interface uploaded to the communication devices (15) via Internet (2). The system is configured to be accessed via Internet (2) because Internet (2) use is widespread. However, the software (11), therefore the database will be optionally accessed through wired or wireless, intranet, or similar systems. The communication devices (15) may be any of the electronic devices comprising a processor and may access the software (11) via Internet such as the smart phones, tablets, notebooks, or desktop computers. A fan (16) has to take the steps presented in FIG. 2 at least, in order to enter the system by using the software (11). These steps are considered to be processes or work method stages. The subscription stages of the platform are described below:
10—subscription to the platform
20—inputting identity and other required information
30—inputting the data of the payment means
40—controlling platform manager
50—selecting team and players to be supported
60—the approval of subscription and notification to the fan

The details of said subscription stages are described below.

### Subscription to the Platform (10):

In this stage, a fan (16) accesses the software (11) through any communication device (15) and logs in.

### To Input Identity and Other Required Information (20):

In this stage, the fan (16) inputs the identity information and further information according to the supporting criteria to the software (11).

### To Input the Data of the Payment Means (30):

In this stage, the fan (16) inputs the information into software (11) according to the payment means to be used for the conditional supporting. Said payment means may be by credit card, and also may be pre-payment by means of buying credit or points in advance. An advance-payment may be optionally required herein.

### To Control Platform Manager (40):

In this stage, the information input by the fan (16) and the payment means are controlled by the platform manager. If they are applicable, the process continues by a “yes” step, and if they are not applicable, the process turns back to the stage of inputting identity and other required information (20) by a “no” step. In this information control, whether there is a manipulation of a speculator group or a terrorist group and the reliability of the payment information are controlled.

### To Select Team and Players to be Supported (50):

A fan (16) selects the team (13) to be supported after the stage of controlling platform manager (40). In this stage, the fan (16) may optionally select the player (12) or a goal or activity (14) also.

### Approval of Subscription and Notification to the Fan (60):

When the fan (16) meets the basic requirements (information input) for the subscription, the subscription is approved and the subscription message is sent them via a message within the software (11) or via mobile phone message.

A fan who has got through the subscription stages described above will be able to provide a conditional support for a sports team (13), a player (12) together with the sports team (13), and a goal or activity (14). Prior to the conditional support, a pre-payment, for example a subscription payment may optionally be required. There may be a team (13), a player (12), or a goal or activity (14) to be conditionally supported by a fan (16) who subscribed to the platform. Considering the above description, this assumption is surely for conditionally supporting the sports activities by the fans. Said support may encompass different fields while protecting the basic criteria. The main point in this support is that “the condition” is present. If the support is in the form of money, said money is paid by the fan (16) in advance, i.e. drawn out of their account, and if the player (12) or the team (13) become successful, or the goal or activity (14) is accomplished, said support is transferred to the relevant positions. If the player (12) or team (13) fails (or they are not at the predetermined level) or the goal or activity (14) is not accomplished, then the relevant support turns back to the fan (16). In other words, the amount is refunded to their account. Said refund may surely be a cost amount determined by the platform manager, or a nominal fee such as operating fee or maintenance fee. “The condition” herein refers to supporting the success by money and the refund of this money in the case of a failure. Such a condition is that a motivation is provided for the player (12), the team (13), and the goal or activity (14), and the required financial source is also provided for the process. For example, when a certain amount of money needs to be allocated for the player transfer, but there is not enough money supply of the sports club, said transfer is considered as a failure. However, by the conditional support system, requesting a conditional support from the fans (16) is possible through said software (11) for this case, i.e. for the goal or activity (14) which is the player transfer fee. If the fans (16) support this decision, they may provide a conditional support through the system of the invention, the adequate money may be allocated, and the transfer may be carried out. Both an actual support is provided and the financial power is increased by the direct participation of the supporters and their financial supports in the sports activities, or other art, business, and entrepreneurship activities. The conditional support management system of the invention allows for conveying the messages of emotional or opinion reactions which are not related to the financial issues such as asking a question, voting, and prevented an undesired situation, as well as the financial support. The motivation may also be determined.

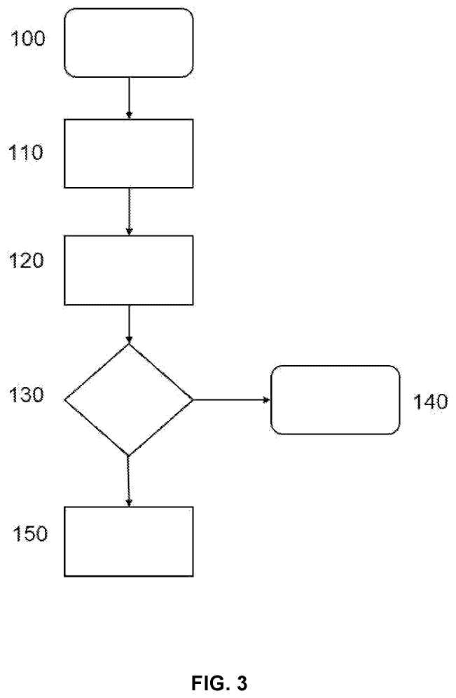

In the conditional support system of the invention, the conditional support of a fan (16) to a player (12), a team (13), or a goal or activity (14) is illustrated in the flow chart of FIG. 3 comprising the minimum processes. These steps are considered to be processes or work method stages. The subscription stages of the platform are described below:

The details of the stages of providing conditional support are described below.
100—selecting the operation to be supported
110—selecting the support condition
120—receiving and reserve the support payment
130—the approval of the support upon examining the result
140—refunding the payment to the fan
150—releasing the payment

The stages of the conditional support described above are as follows:

### To Select the Element to be Supported (100):

At least one of the team (13), the player (12), or the goal or activity (14) is selected to support in this stage. This selection may be a selection not limited to the time and open to the general subscription, and may be a selection limited to the criteria determined by the platform manager (1) such as time or the completion of the process.

### To Select the Support Condition (110):

In this stage, supporting at least one of the selected team (13), the player (12), or the goal or activity (14) is determined as the support condition of the success criteria limited by the case or time. Said support may be the conditions such as goals scored by a player (12) over a season, credits of the fans for a player (12) for the successes, winning a match or a competition, a championship, and a player transfer. Said conditions are effective in the cases that the support is eventuated or withdrawn. Said conditions may also be the conditions such as building a concert hall for the activities of art, or making a prototype for an entrepreneurship activity.

### To Receive and Reserve the Support Payment (120):

In this stage, the fan (16) makes the support payment according to one of the predetermined means of support payment. The support payment is reserved for controlling whether the support condition is met, by the platform manager (1). This control will be carried out by checking whether the determined conditional support is made or not transparently.

Approval of the Support upon Examining the Result (130):

Whether the support condition is met is controlled for the results of the support payment received from the fan (16) and reserved. If the support condition is met, the process passes to the next stage upon the “yes” criteria, if said support condition is not met, the process passes to the stage of refunding the payment to the fan (140) upon the “no” criteria, and the support payment is refunded to the fan (16).

### To Refund the Payment to the Fan (140):

If the support condition is not met, the received and reserved payment (support fee) is refunded to the fan (16). In this stage, the platform manager (1) may surely receive the costs or a predetermined amount of fee in return for the services.

### To Release the Payment (150):

If the support condition is not met, the support payment (support fee) received from the fan (16) and reserved is supplied to the any one of the team (13), the player (12), or the goal or activity (14), based on the guarantee to be supported. The platform manager (1) may surely carry out a cut as a cost or service fee. The service fee of the platform manager (1) may be received during the subscription of the fan (1) or while receiving the first support payment to be reserved.

In the conditional support management system of the invention, the support will be transferred to any one of the team (13), the player (12), or the goal or activity (14) to be supported form the fans (16), based on the guarantee to be supported. In said system, the process of providing a conditional support of the fan (16) is basically operated according to the flow procedures illustrated in FIG. 3 and described above. However, during said flow procedures, the activities such as consulting the fan (16) on a case or voting their ideas, etc. may be carried out. The ideas on which one of the team (13), player (12), or the goal or activity (14) is to be supported, what kind of support will be provided to all or some of them may be inquired, then the actual supporting fields may be determined. For example, selection of the players in a football league, the ideas of the club on this, and the selection of the fan may be inquired. This inquiry may be by point scoring or by financial support. Also, a conditional support campaign may be arranged according to the success of a team in the matches of a football league or according to the performances of the players in said team. These supports may be provided for anyone or any case such as the club chairman, the coach, the scorer players, or the goalkeeper.

### Industrial Applicability of the Invention

The conditional support management system of the invention is mainly a way of guiding the decisions of the clubs, teams, the players, and the managers in the sports activities, supporting them, or delivering the criticisms and it also provides the financial support according to the success (the success herein is the condition). This basic system may also be used as an encouraging factor for the organization of a concert of an artist, for a new composition, or for writing a new book. Similarly, the conditional support system may be used for supporting a business enterprise or an investment.

What is claimed is:

1. A conditional support management system, comprising
at least one fan,
at least one team supported by or in connection with the at least one fan,
at least one player playing in the at least one team or independently,
at least one goal or activity, wherein the at least one team or the at least one player are competing for an achievement for the at least one goal or activity,
a server system comprising databases of the at least one team, the at least one player, and the at least one goal or activity through a software and bringing the databases into service via Internet,
a platform manager providing a management of the software and other elements,
communication devices using the software by authorities supplied by the platform manager allowing for accessing database information through a satellite or base stations, and the at least one fan accessing the databases of the at least one team, the at least one player and the at least one goal or activity through the software and the communication devices and providing a conditional support, wherein the conditional support management system is configured for the at least one fan to provide the conditional support for the at least one player, the at least one team, or the at least one goal or activity, and a method for provided the conditional support comprises the following steps:
selecting an element to be supported;
selecting a support condition;
receiving and reserve a payment;
an approval of the support condition upon examining a result;
refunding the payment to the at least one fan; and
releasing the payment.

2. The conditional support management system according to claim 1, wherein at least one of the at least one team, the at least one player, or the at least one goal or activity to be supported is selected in the step of selecting the element to be supported.

3. The conditional support management system according to claim 1, wherein a selection is not limited to a time and open to a general subscription, and is limited to a criteria determined by the platform manager, wherein the criteria is the time or a completion of a process, in the step of selecting the element to be supported.

4. The conditional support management system according to claim 1, wherein the step of selecting the support condition comprises the step of determining the conditional support for at least one of the at least one team, the at least one player, or the at least one goal or activity as the support condition of a success criteria limited by a case or a time.

5. The conditional support management system according to claim 1, wherein in the step of receiving and reserving the payment, the at least one fan carries out the payment according to at least one of determined support payment means and payment is reserved to allow the platform manager to control whether the support condition is met.

6. The conditional support management system according to claim 1, wherein in the step of the approval of the support upon examining the result, whether the support condition is met is controlled for results of the payment received from the at least one fan and kept reserved; if the support condition is met, a process passes to a next stage upon a “yes” criteria; if the support condition is not met, the process passes to the step of refunding the payment to the at least one fan upon a “no” criteria, and the support payment is refunded to the at least one fan.

7. The conditional support management system according to claim 1, wherein the step of refunding the payment to the at least one fan comprises the step of refunding the payment received from the at least one fan and kept reserved if the support condition is not met.

8. The conditional support management system according to claim 1, wherein in the step of refunding the payment to the at least one fan, the platform manager receives costs or a predetermined fee in return for services.

9. The conditional support management system according to claim 1, wherein in the step of releasing the payment, the payment received from the at least one fan and kept reserved is provided for one of the at least one team, the at least one player, or the at least one goal or activity, based on a guarantee to be supported, when the support condition is met.

10. The conditional support management system according to claim 1, wherein the step of releasing the payment comprises a step of carrying out cuts as service charge or a cost of the platform manager.

11. The conditional support management system according to claim 1, wherein a service fee of the platform manager is received during a subscription of the at least one fan or while receiving a first support payment to be reserved.

12. The conditional support management system according to claim 2, wherein a selection is not limited to a time and open to a general subscription, and is limited to a criteria determined by the platform manager, wherein the criteria is the time or a completion of a process, in the step of selecting the element to be supported.

13. The conditional support management system according to claim 7, wherein in the step of refunding the payment to the at least one fan, the platform manager receives costs or a predetermined fee in return for services.

14. The conditional support management system according to claim 9, wherein the step of releasing the payment comprises a step of carrying out cuts as service charge or a cost of the platform manager.

15. The conditional support management system according to claim 7, wherein a service fee of the platform manager is received during a subscription of the at least one fan or while receiving a first support payment to be reserved.

16. The conditional support management system according to claim 7, wherein a service fee of the platform manager is received during a subscription of the at least one fan or while receiving a first support payment to be reserved.
